(19) United States
(12) Patent Application Publication
(10) Pub. No.: US 2025/0018300 A1
(43) Pub. Date: Jan. 16, 2025

(54) USER MOOD MONITORING IN INFORMATION HANDLING SYSTEM USING BIOFEEDBACK FROM WIRELESS CONTROLLER

(71) Applicant: Dell Products L.P., Round Rock, TX (US)

(72) Inventors: Jason Scott Morrison, Chadron, NE (US); Ryan Nicholas Comer, Round Rock, TX (US)

(73) Assignee: Dell Products L.P., Round Rock, TX (US)

(21) Appl. No.: 18/353,072

(22) Filed: Jul. 15, 2023

(51) Int. Cl. A63F 13/67; A63F 13/212; A63F 13/218; A63F 13/23; A63F 13/285; A63F 13/79

(52) U.S. Cl. CPC A63F 13/67; A63F 13/212; A63F 13/218; A63F 13/23; A63F 13/285; A63F 13/79

(57) ABSTRACT

Systems and methods described herein may provide a system that enables game play or other application sessions from a set of candidate game hosts and environments to consumption devices of a user's choice while the user moves about their home between the different environments. The system may employ methods to determine where a user is located within the home, availability and selection of candidate game hosting and target environments, homing and direction of related I/O and audio-visual (AV) content for consumption. The solution accommodates multiple users simultaneously within the home, whether in single player, multiplayer using the same screen, or multiplayer using separate screen games. The solution may configure AV and input/output (I/O) such that multiple users can consume one or multiple games in the home simultaneously, whether in separate locations or when seated together in front of the same consumption device.

### FIELD OF THE DISCLOSURE

The instant disclosure relates to information handling systems. More specifically, portions of this disclosure relate to execution of applications in a multi-room user environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY

Information handling systems, such as a network hub device, may execute applications such as gaming applications. Players of gaming applications may experience deleterious effects on their mood as a result of stressful aspects of the gaming applications (e.g., game difficulty, long duration of gaming sessions, intensity of online multiplayer sessions, stressful design of in-game levels). Aspects of embodiments of this disclosure monitor information regarding one or more players for determining moods of the one or more players while playing the gaming applications. The mood information can be used as input to rules that perform actions that can assist a user with regulating their mood, thereby improving the players' experience playing on the gaming applications.

In some embodiments, the aspects described herein may be used to support the execution of gaming applications in different environments. Gaming sessions may execute on a service, either locally on a device, on another system on the network, or in the cloud. A device may access the gaming session by executing an application that communicates with the service to receive and transmit user input to the service and provide feedback to the user from the service. The device may include its own audio/visual (AV) output for displaying a graphical user interface and/or a rendered display from the gaming session. Different environments at a location may include different AV systems, and the device may be automatically paired with an AV system and may be reconfigured to support interaction with an application session using the paired AV system.

A user's home is one example location that may have multiple environments, such as a living room, a dining room, a study, and/or a bedroom, each with different screen configurations, speaker configurations, and/or network availability. Aspects of embodiments disclosed herein may provide a system that enables game play from a set of candidate game hosts and environments to consumption devices of a user's choice while the user moves about their home between the different environments. The system may employ methods to determine where a user is located within the home, availability and selection of candidate game hosting and target environments, homing and direction of related I/O, and/or AV for consumption. The system then migrates the user and their information to the determined environment by coordinating gameplay by the user. The solution accommodates multiple users simultaneously within the home, whether in single player, multiplayer using the same screen, or multiplayer using separate screen games. The solution may configure AV and input/output (I/O) such that multiple users can consume one or multiple games in the home simultaneously, whether in separate locations or when seated together in front of the same consumption device, e.g., a large television, where multiple games might be hosted simultaneously.

The mobility of a user between services and applications for executing an application session may be supported by an information handling system that uses available telemetry from multiple sources to build a confidence-based knowledge graph of the user's gaming environments and determine a position of the user within that graph. A system with knowledge of devices in a user's gaming environment may build a knowledge graph by aggregating and comparing telemetry. For example, network telemetry may reveal that devices are positioned relatively near each other, a mobile device may reveal an absolute location based on GPS data, and/or an infrared presence sensor may reveal that the user is sitting in front a device. An intelligent system may assemble these individual pieces of telemetry into a broader knowledge graph based on the absolute and/or relative locations of the user's devices, the location of the user in relation, and or characteristics of the devices. This knowledge graph may be updated in real time and/or based on changes in device telemetry.

According to one embodiment, a method for execution by an information handling system, such as a hub device, includes receiving, by a hub device during the execution of a gaming application on the hub device, one or more biofeedback indicia for a player of the gaming application via a controller communicatively coupled to the hub, a player profile associated with the player, and in-game contextual information; determining, by the hub device, a first mood value for the player based on the one or more biofeedback indicia, the player profile, and the in-game contextual information; determining, by the hub device, that the first mood value satisfies one or more criteria, wherein the one or more criteria is determined based on the player profile and the in-game contextual information; and executing, by the hub device in response to determining that the first mood value satisfies the one or more criteria, an action based on a rule, wherein the rule is based on the first mood value, the player profile, and the in-game contextual information. The result may improve a player's experience during a gaming session by monitoring the mood of the player while he or she plays on the gaming application and initiating actions for remedying a declining mood of the player caused by aspects of the gaming session.

In certain embodiments, the method described above may further comprise receiving, by the hub device, after the executing, one or more second biofeedback indicia for the player; determining, by the hub device, a second mood value of the player based on the one or more second biofeedback indicia, the player profile, and the in-game contextual information; evaluating, by the hub device, that the second mood value is greater than the first mood value; identifying, in response to the evaluating and using machine learning, a positive causal relationship between the first mood value, the action, and the second mood value; and recording, by the hub device, the positive causal relationship, wherein the recording comprises adding the positive causal relationship into a plurality of recorded causal relationships included in the player profile.

In certain embodiments, the method described above may further comprise receiving, by the hub device, after the executing, one or more second biofeedback indicia for the player; determining, by the hub device, a second mood value of the player based on the one or more second biofeedback indicia, the player profile, and the in-game contextual information; evaluating, by the hub device, that the second mood value is not greater than the first mood value; identifying, in response to the evaluating and using machine learning, a negative causal relationship between the first mood value, the action, and the second mood value; and recording, by the hub device, the negative causal relationship, wherein the recording comprises adding the negative causal relationship into a plurality of recorded causal relationships included in the player profile.

In certain embodiments, the method described above may further comprise identifying, in response to determining that the first mood value satisfies the one or more criteria and using machine learning, a negative causal relationship between the in-game contextual information and the first mood value; and recording, by the hub device, the negative causal relationship, wherein the recording comprises adding the negative causal relationship into a plurality of recorded causal relationships included in the player profile.

The method may be embedded in a computer-readable medium as computer program code comprising instructions that cause a processor to perform operations corresponding to the steps of the method. In some embodiments, the processor may be part of an information handling system including a first network adaptor configured to transmit data over a first network connection; and a processor coupled to the first network adaptor, and the memory.

As used herein, the term “coupled” means connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially parallel includes parallel), as understood by a person of ordinary skill in the art.

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating aspects of a configurable system for providing services to users according to some embodiments of the disclosure.

FIG. 2 is a block diagram illustrating possible game environments according to some embodiments of the disclosure.

FIG. 3A is a block diagram illustrating application and services hosted in different gaming environments according to some embodiments of the disclosure.

FIG. 3B is a block diagram illustrating application and services hosted in different gaming environments according to some embodiments of the disclosure.

FIG. 3C is a block diagram illustrating application and service hosted in a common gaming environment according to some embodiments of the disclosure.

FIG. 3D is a block diagram illustrating a cloud-based service arrangement for a gaming environment according to some embodiments of the disclosure.

FIG. 4 is a diagram illustrating a system for monitoring and regulating moods of a player of embodiments of gaming applications according to some embodiments of the disclosure.

FIG. 5A illustrates a frontal view of an embodiment of a controller configured to measure biofeedback indicia of a player of a gaming application.

FIG. 5B illustrates a rear view of an embodiment of a controller configured to measure biofeedback indicia of a player of a gaming application.

FIG. 6 is an operational flow diagram illustrating a method for monitoring and regulating moods of a player of gaming applications according to some embodiments of the disclosure.

FIG. 7 is an operational flow diagram illustrating a method for monitoring and regulating moods of a player of gaming applications according to some embodiments of the disclosure.

FIG. 8 is an operational flow diagram illustrating a method for monitoring and regulating moods of a player of gaming applications according to some embodiments of the disclosure.

FIG. 9 is a schematic block diagram of an example information handling system according to some embodiments of the disclosure.

### DETAILED DESCRIPTION

These example embodiments describe and illustrate various aspects of a configurable and dynamic gaming environment that can be supported through the use of a hub device, which may be an information handling system. The hub device may implement methods for monitoring the mood of users interacting with the hub device. For example, the hub device may receive information from a wireless controller or other wireless device associated with a user, which may provide biofeedback indicia about the user while in-game. The hub device may determine a mood of the user based on the biofeedback indicia, determining a changing mood of the user during interaction with the dynamic gaming environment, and perform actions to assist the user with regulating their mood. The example actions may involve aspects of the dynamic gaming environment described herein, such as by suggesting the user move from one room to another room or identifying the room the user is in has a certain seating configuration and suggesting the user sit down to reduce stress. The hub device may enforce certain suggestions by, for example, monitoring the user's location to determine compliance with a request, transferring the user's gaming session to another device in the household, or pausing the user's gaming session for a certain period time. Although example gaming environments involving the hub device are described here, the methods described herein are not limited to application on a hub device or the particular household environment. For example, the methods may be performed by an information handling system interacting with a user through a wired or wireless gaming controller.

A hub device may be located in a user's home and used to arrange game play sessions (or more generically application sessions) between host devices and services. The host devices may execute an application for receiving an AV stream for displaying rendered content from a game play session (or other application session), and in some configurations also receive user input for interacting with the session from a peripheral device, such as a gaming controller. The AV stream presented by the host device may be generated by a service. The service may execute on the hub device or another information handling system, such as a cloud computing resource. A home may include one or several host devices (e.g., televisions, mobile computers, tablet computers, and personal computers) and may include one or several information handling systems executing the service (e.g., a hub devices and personal computers).

The user's home may be divided into different environments defined by a space around a host device. For example, a living room with a television may be one environment and a bedroom with a personal computer may be another environment. A user may use a peripheral device in one of the environments and the hub device may configure a host device, a service, and the peripheral device for operation in the environment by determining the corresponding environment using a knowledge graph. The knowledge graph provides a database of historical information about the environments from which the hub device may use current characteristics of the peripheral device to deduce the location, and thus current environment, of the peripheral device. For example, the knowledge graph may include information about location of rooms (e.g., environments) in the house based on wireless signatures of devices within the different rooms. This difference in signatures reflects that a device on a one side of the house may receive beacon signals from different neighboring access points than a device on an opposite side of the house. When a user carries the peripheral device around the house, the hub device may determine a location of the peripheral device based on visible access points to the peripheral device. Other example characteristics beyond wireless signature for determining location are described in further detail below, and the knowledge graph may be used to combine different characteristics to identify the location, and thus environment, of the peripheral device.

Based on the location of the peripheral device determined from the knowledge graph, the hub device may initialize an application session for the peripheral device by determining an appropriate host device and service for the application session. For example, if the peripheral device is in the living room and is requesting a game that is within the capabilities of the service on the hub device to execute, the hub device may initialize an application session for the peripheral device between the television as a consumption device and the hub device as a service. The service on the hub device executes the game and streams rendered content to an application executing on the television consumption device.

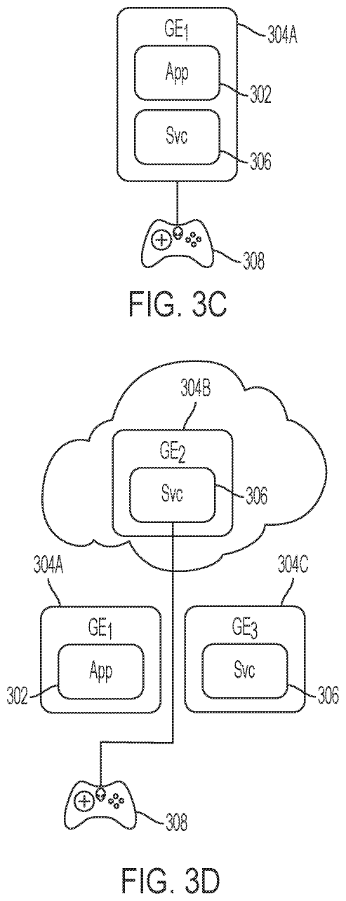

The hub device may be used to migrate the peripheral device to a different environment and/or migrate the application session between host devices and/or services. For example, initially the application session may use a communication link between the peripheral device and the television host device for receiving user input, in which the application executing on the television host device relays user input to the service through a backhaul communication link from the television host device to the hub device. During the application session, the hub device may monitor characteristics of the peripheral device, including signal strength of connection to other components, and determine that the communication link from the peripheral device to the hub device is stronger than the peripheral device to the television host device. The hub device may migrate the peripheral device to a communications link with the hub device such that the service executing on the hub device directly receives the user input but the streaming session continues from the service to the application executing on the television host device. Such a change is illustrated in the change in configuration from FIG. 3A to the configuration of FIG. 3B described in further detail below.

Other aspects of the application session may also be migrated. For example, if the peripheral device is determined to move to a different environment, then the hub device may migrate the application session to an application executing on a host device within the new environment. As another example, if a connection between the television host device and the service becomes unstable, the hub device may recommend and/or initiate a migration of the application session to a different host device. One scenario for such a migration may be where the television host device is connected through a wireless link to the service in which the wireless link quality is reducing quality of the streaming and a second host device with a wired connection is available in a nearby environment. Each of these example migrations may be determined based on information in the knowledge graph regarding locations of environments and capabilities within those environments. As yet another example, a user may request execution of an application, such as a particular game, during the application session for which a better configuration exists than the current host device and/or current service. The request for a different application, such as a game requiring a certain GPU capability, may cause the hub device to determine that a second device executing a second service is better for hosting the application and migrate the peripheral device to the second service by, for example, reconfiguring network connections.

The hub device may support connecting to multiple peripheral devices. In one example, the hub device may support two peripheral devices using a shared session on one host device to play the same or different games on the host device. In another example, the hub device may support two peripheral devices in different environments using different sessions with different host devices. The hub device may determine the environment of each of the peripheral devices based on characteristics of the device and the knowledge graph and configure application session for each of the peripheral devices accordingly. Different arrangements of peripherals and players may be supported. For example, one hub device executing a service and one host device executing an application can support a configuration with Game A and one player (P1) with peripheral (C1) and Game B and one player (P2) with peripheral (C2); or can support a configuration with Game A and one player (P1) with peripheral (C1) and Game A and one player (P2) with peripheral (C2); or can support a configuration with Game A and two players (P1, P2) with peripherals (C1, C2).

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

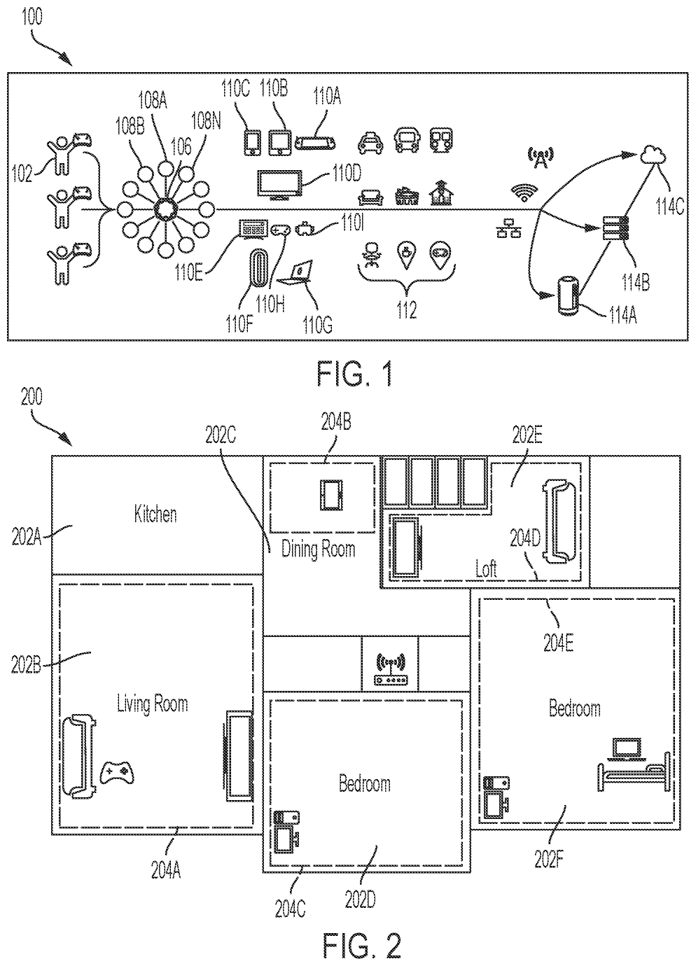

FIG. 1 is a block diagram illustrating aspects of a configurable system for providing services to users according some embodiments of the disclosure. A system 100 includes users 102 who may have access to a shared library of applications 106 including applications 108A-108N. The users 102 may have separate libraries, with some overlapping applications between the libraries. The users 102 may access the library 106 through devices 110A-I, such as mobile gaming device 110A, tablet computing device 110B, phone computing device 110C, television 110D, personal computing device 110E, desktop computing device 110F, laptop computing device 110G, game controller 110H, VR headset 110I. The devices 110 may access services at any of locations 112, including cars, busses, homes, hotels, offices, parks, etc. One or more of the devices 110 may communicate with an application session executing on a computing device 114, such as a home application hub 114A, a server 114B, or a cloud execution environment 114C. In some embodiments, environments may only exist for fixed devices, e.g., desktop computers, televisions, etc.

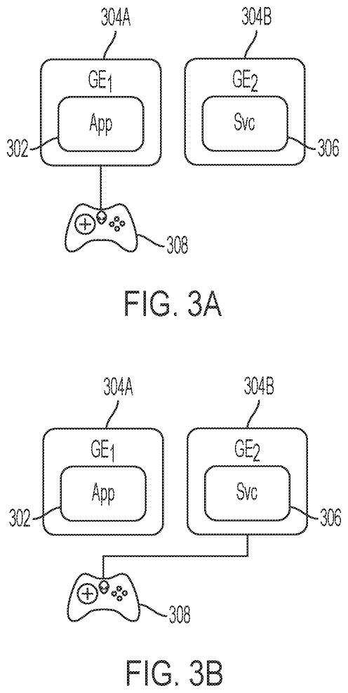

FIG. 2 is a block diagram illustrating possible game environments according to some embodiments of the disclosure. A user's home 200 may include rooms 202A-F, and each of the rooms may have different information handling systems present, different AV equipment present, and/or different characteristics. For example, a living room 202B may include a large-size television, a bedroom 202D may include a personal computer, and a dining room 202C may include a table computing device. Gaming environments 204A-E in the home 200 may be defined based on spaces where a user is likely to execute an application session. Each gaming environment 204A-E may include numerous devices and gaming environments, devices that may or may not be capable of hosting games, and/or devices that may or may not be capable of receiving game output. A system 100 may allow multiple users in the home 200 to simultaneously execute an application session. In some embodiments, multiple games may be hosted on a single device. In some embodiments, multiple games may target a single output device. In some embodiments, solution manages where games should be hosted, where game output should go, and how to best route peripheral I/O for users.

A user may move between gaming environments 204A-E within the home 200 and continue an application session. For example, a user may take a device, such as a gaming controller, from environment 204A to environment 204C. The gaming controller may migrate and reconfigure for operation in environment 204C from a configuration for environment 204A. For example, the controller may transition from an application hosted on a TV in living room 202B to an application hosted on TV in dining room 202C while remaining connected to a host service executing on a PC in bedroom 202D.

Example configurations for applications and services in gaming environments are shown in FIGS. 3A-3D. FIG. 3A is a block diagram illustrating application and services hosted in different gaming environments according to some embodiments of the disclosure. In FIG. 3A, a first gaming environment 304A may include a device, such as a TV or PC, hosting an application 302, which is an endpoint for an application session such as a gaming session. The application 302 communicates with a service 306, which may be hosted on a device in a different gaming environment 304B. A controller 308 may communicate with the application 302 to receive user input for the application session to control, for example, a character in a game. In some embodiments, the controller 308 is connected to the environment 304A hosting the application and the I/O is configured to be relayed to the environment 304B hosting the actual game.

Another arrangement for the application and service is shown in FIG. 3B. FIG. 3B is a block diagram illustrating application and services hosted in different gaming environments according to some embodiments of the disclosure. In FIG. 3B, the controller 308 communicates with the service 306 for providing user input to an application session, with the AV rendering target of the application session being application 302 in a different gaming environment.

Another arrangement for the application and service is shown in FIG. 3C. FIG. 3C is a block diagram illustrating application and service hosted in a common gaming environment according to some embodiments of the disclosure. In FIG. 3C, the application 302 and the service 306 are executed in the same gaming environment 304A, which may be a single device, two devices, or a combination of devices in the gaming environment 304A. The controller 308 may communicate with either the service 306 and/or the application 302.

A further arrangement for the application and service is shown in FIG. 3D. FIG. 3D is a block diagram illustrating a cloud-based service arrangement for a gaming environment according to some embodiments of the disclosure. In FIG. 3D, the controller 308 may communicate with a service 306 hosted in a gaming environment 304B that is remote from the gaming environment 304A in which the application 302 is executing. The service 306 may be executing, for example, on a remote device, such as when the user's home includes the gaming environment 304B but the user is engaging with application 302 at a location on a different network from their home (e.g., at a friend's house). The service 306 may also or alternatively be executed, for example, on a cloud computing device available as a subscription service to the user.

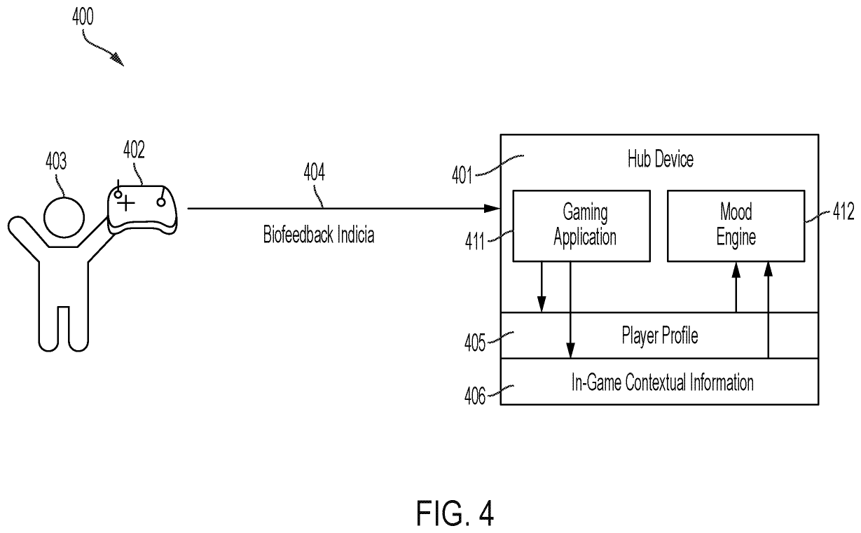

FIG. 4 is a diagram illustrating a system 400 for monitoring and regulating moods of a player of embodiments of gaming applications described above. In certain embodiments, system 400 may include a hub device 401 on which a gaming application may be executed and a controller 402 communicatively coupled to hub device 401 whereby a player 403 interacts with the gaming application via the controller 402. Controller 402 may be coupled to hub device 401 via a wireless connection or a physical connection. Controller 402 may be configured to measure biofeedback indicia 404 and hub device 401 may be configured to receive biofeedback indicia 404 from controller 402. Biofeedback indicia 404 may include, but is not limited to, a heart rate of player 403, a grip force of player 403 on controller 402, or a combination thereof. Hub device 401 may also be configured to receive a player profile 405, in-game contextual information 406, or a combination thereof. Player profile 405 may include, but is not limited to, preference information entered by player 403, tendency information associated with player 403 and recorded automatically by hub device 401, or a combination thereof. In-game contextual information 406 may include, but is not limited to, information regarding in-game difficulty level, in-game progress status, single player game mode status, multiplayer game mode status, online multiplayer game mode status, game session length, or a combination thereof. In-game contextual information 406 may be continuously monitored by hub device 401 or captured at discreet times. Hub device 401 may receive player profile 405 and in-game contextual information 406 from internal memory included on hub device 401, a local server communicatively coupled with hub device 401, a cloud server communicatively coupled with hub device 401, or a combination thereof.

The hub device 401 may execute the gaming application 411, which generates the player profile 405 and/or in-game contextual information 406. The hub device 401 may execute a mood engine 412 that consumes the player profile 405, the in-game contextual information 406, and/or the biofeedback indicia to determine the user's mood. The mood engine 412 may include a set of predetermined rules to apply to the various data to make determinations, such as a mood value determination or an action for assisting with mood regulating. The mood engine 412 may also adapt and learn by monitoring the player 403's mood changes in response to certain actions and adapt future actions based on this feedback.

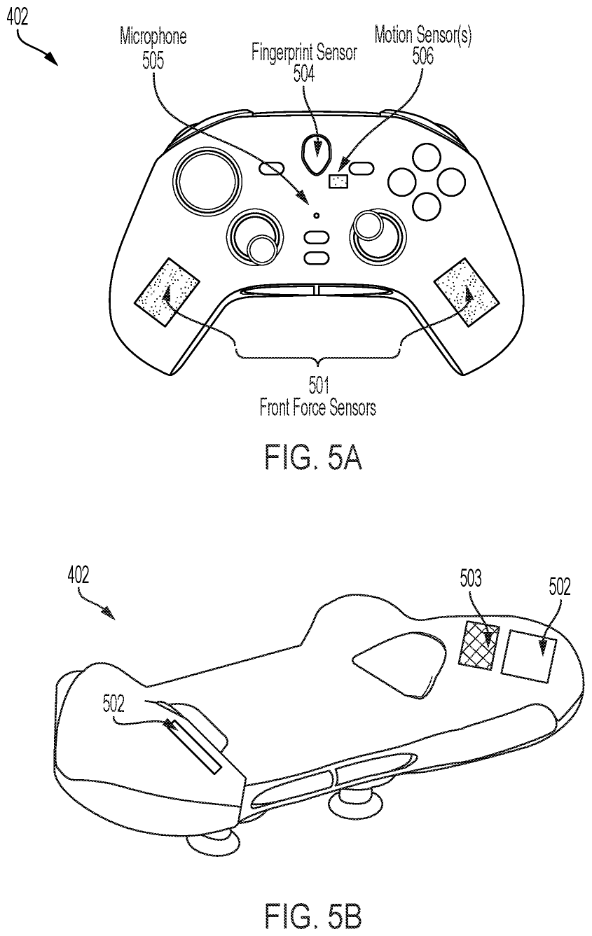

FIGS. 5A and 5B illustrate a controller 402 configured to measure biofeedback indicia 404 according to some embodiments of this disclosure. As shown in FIG. 5A, controller 402 may include front force sensors 501 located on the front faces of the gripping surfaces of controller 402. As shown in FIG. 5B, controller 402 may also include rear force sensors 502 located on the rear faces of the gripping surfaces of controller 402. Biofeedback indicia 404 may include grip force of player 403, measured via force sensors 501 and 502. Measurement of the grip force may be done by summing the forces detected on the front force sensor 501 and the rear force sensor 502 of the left gripping surface, summing the forces detected on the front force sensor 501 and the rear force sensor 502 of the right gripping surface, and combining the two sums (e.g., by summing, averaging, taking the maximum between the two). In some embodiments, grip force may be measured via force sensor pairs located on faces of the gripping surfaces of controller 402 other than the front and rear faces, via more than two pairs of force sensors, via less than two pairs of force sensors, via unpaired force sensors, or via a combination thereof. Further, as shown in FIG. 5B, controller 402 may also include an optical heart rate monitor 503 for measuring the heart rate of player 403 to be included in biofeedback indicia 404. In other embodiments, optical heart rate monitor 503 may be placed at any other location on controller 402 which makes contact with player 403. Additionally, in some embodiments, controller 402 may comprise additional features including, but not limited to, fingerprint sensor 504, microphone 505, motion sensor 506, and antenna 507. Some embodiments of controller 402 may also include one or more temperature sensor(s), one or more moisture sensor(s), or a combination thereof placed at any location on controller 402 which makes contact with player 403.

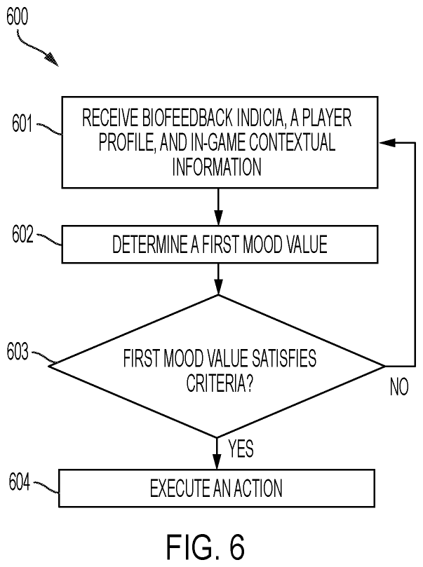

FIG. 6 is an exemplary operational flow diagram illustrating a method 600 for implementing a system for monitoring and regulating moods of a player of gaming applications in accordance with embodiments described above. In the example of FIG. 6, system 400 operates as follows: hub device 401 monitors the mood of player 403 during execution of a gaming application by receiving biofeedback indicia 404 regarding player 403 via controller 402 as player 403 interacts with the gaming application using controller 402, as noted in block 601.

At block 601, hub device 401 also receives player profile 405, associated with player 403, and in-game contextual information 406, associated with the gaming application being executed, in addition to biofeedback indicia 404. At block 602, hub device 401 determines a first mood value representing a current mood of player 403 as he or she interacts with the gaming application. Hub device 401 determines the first mood value based on biofeedback indicia 404, player profile 405, and in-game contextual information 406. In some embodiments, player profile 405 may include a mapping relating grip force and heart rate measurements for player 403 to mood values, whereby hub device 401 sets the first mood value by relating the grip force and heart rate measurements received with a mood value through the mapping of player profile 405. Further, in some embodiments, hub device 401 may modify a mapping provided by player profile 405 in light of in-game contextual information 406 received so as to factor the current game context and its effect on the mood of player 403 into the determination of the first mood value. For example, under more stressful in-game conditions (e.g., higher difficulty level, longer duration of game session, online multiplayer session), a greater range of lower intensity of biofeedback indicia (e.g., lower grip force values, lower heart rate values) may result in mood values representing undesirable moods of player 403.

At block 603, hub device 401 determines whether the determined first mood value satisfies one or more criteria. The one or more criteria may be determined based on player profile 405 and in-game contextual information 406. In some embodiments, player profile 405 may include a list of mood values for which hub device 401 must take action. In other embodiments, player profile 405 may include a list of factors that a mood value must satisfy for hub device 401 to be required to take action. Further, in some embodiments, hub device 401 may modify a list of mood values or list of factors provided by player profile 405 in light of in-game contextual information 406 received so as to factor the current game context and its effect on the mood of player 403 into the determination of whether the hub device must take action in response to the first mood value. For example, under more stressful in-game conditions (e.g., higher difficulty level, longer duration of game session, online multiplayer session) the one or more criteria may be more easily met by a greater range of mood values. The one or more criteria may be determined dynamically as player profile 405 or in-game contextual information 406 are updated. Hub device 401 may determine the one or more criteria or may receive the one or more criteria from an internal memory or from an external server.

If, during block 603, hub device 401 determines that the determined first mood value fails to satisfy the one or more criteria, hub device 401 returns to block 601 and continues to monitor the mood of player 403 by receiving updated biofeedback indicia 404, updated information of player profile 405, and updated in-game contextual information 406. If, however, during block 603, hub device 401 determines that the determined first mood value satisfies the one or more criteria, then hub device 401 proceeds to block 604, wherein hub device 401 executes an action. Example actions may include, but are not limited to, initiating haptic cues to player 403 via controller 402 (e.g., causing controller 402 to vibrate in the hands of player 403 at a particular intensity and rhythm), initiating visual lighting cues to player 403 via controller 402 (e.g., causing a change of color of light emitted by a light-emitting diode (LED) ring housed within the casing of controller 402), or a combination thereof. Which particular action or combination of actions hub device 401 executes during block 604 is based on the determined first mood value, player profile 405, and in-game contextual information 406. In some embodiments, player profile 405 may include a mapping relating mood values to action(s) to be executed, whereby hub device 401 determines the action(s) to be executed by relating the determined first mood value to an action or combination of actions to be executed though the mapping of player profile 405. Further, in some embodiments, hub device 401 may modify a mapping provided by player profile 405 in light of in-game contextual information 406 received so as to factor the current game context and its effect on the mood of player 403 into the determination which action to execute. For example, player profile 405 may map the determined first mood value to an action of causing an LED ring inside controller 402 to emit light, whereas in-game progress information included in the in-game contextual information 406 may determine the color of light for the LED ring to emit (e.g., controller 402 emits a bright hue of light when player 403 is playing on a dark or gloomy level of the gaming application). As another example, player profile 405 may map the determined first mood value to an action of causing controller 402 to vibrate, whereas in-game context may determine the intensity of vibration (e.g., controller 402 is caused to vibrate at lower intensity during more stressful gameplay such as online multiplayer sessions or sessions on higher difficulty setting).

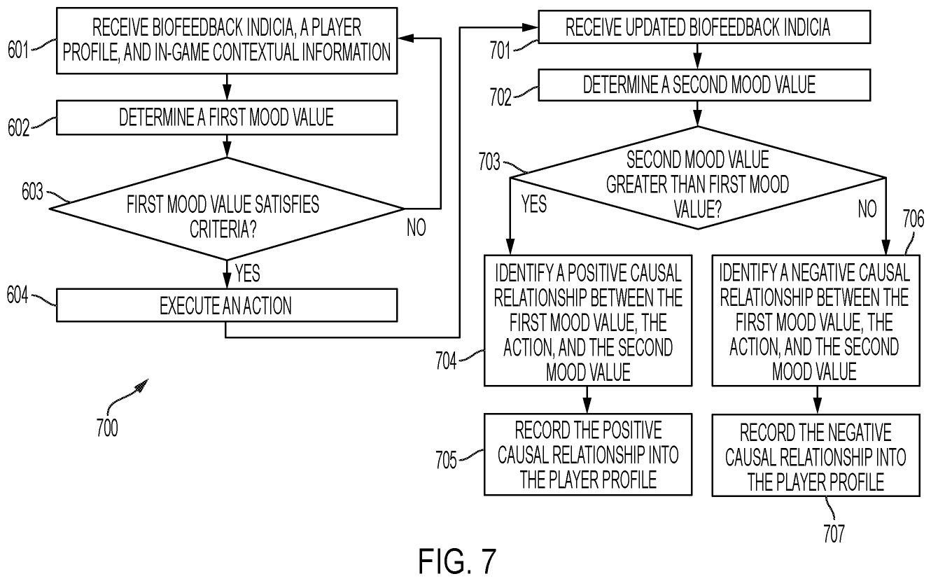

FIG. 7 is an exemplary operational flow diagram illustrating a possible method 700 for implementing a system for monitoring and regulating moods of a player of gaming applications in accordance with embodiments described above wherein player profile 405 may be updated dynamically using machine learning and based on responses of player 403 to actions executed by hub device 401. In the example of FIG. 7, system 400 operates according to the steps of method 600, described above, through block 604 wherein hub device 401 executes an action in accordance with embodiments described above. In some embodiments, after executing an action, hub device 401 may receive updated biofeedback indicia via controller 402 and determine a second, updated mood value based on the updated biofeedback indicia, player profile 405, and in-game contextual information 406, as noted in blocks 701 and 702, respectively. Hub device 401 may determine the second, updated mood value based on the updated biofeedback indicia wherein the updated biofeedback indicia samples the physical condition of player 403 subsequent to hub device 401 executing an action in block 604 such that the second, updated mood value represents the mood of player 403 in response to the action executed by hub device 401 in block 604. Hub device 401 may execute blocks 701 and 702 in accordance with embodiments described above with respect to blocks 601 and 602, respectively.

At block 703, hub device 401 evaluates whether the second mood value is associated with a more desirable mood than that of the first mood value. In the present embodiment, higher mood values are associated with more desirable moods and lower mood values are associated with less desirable moods, therefore, hub device 401 evaluates whether the second mood value is associated with a more desirable mood than that of the first mood value by evaluating whether the second mood value is greater than the first mood value. In other embodiments, lower mood values may be associated with more desirable moods than higher mood values, in which case, hub device 401 may evaluate whether the second mood value is associated with a more desirable mood than that of the first mood value by evaluating whether the second mood value is less than the first mood value.

In some embodiments, an evaluation by hub device 401 that the second mood value is greater than the first mood value results in hub device 401 proceeding to block 704, wherein hub device 401 may identify, using an AI algorithm implemented through one or more machine learning models, a positive causal relationship between the first mood value, the action executed by hub device 401 during block 604, and the second mood value. In some embodiments, this positive causal relationship may represent that the mood of player 403 improved in response to the action executed by hub device 401. Further, player profile 405 may include a plurality of recorded causal relationships associated with player 403 and the identification of a positive causal relationship by device 401 may result in a dynamic update of player profile 405 comprising recording the positive causal relationship by adding it into the plurality of recorded causal relationships of player profile 405, as noted in block 705. Recording such causal relationships may be desirable because an updated player profile 405 including such information may allow hub device 401 to more efficiently select actions to execute more likely to improve the mood of player 403 (e.g., select action(s) that have been recorded to have improved the mood of player 403 under similar circumstances in the past).

In the present embodiment, an evaluation by hub device 401 that the second mood value is not greater than the first mood value results in hub device 401 proceeding to block 706, wherein hub device 401 may identify, using an AI algorithm implemented through one or more machine learning models, a negative causal relationship between the first mood value, the action executed by hub device 401 during block 604, and the second mood value. In some embodiments, this negative causal relationship may represent that the mood of player 403 did not improve in response to the action executed by hub device 401. Further, player profile 405 may include a plurality of recorded causal relationships associated with player 403 and the identification of a negative causal relationship by device 401 may result in a dynamic update of player profile 405 comprising recording the negative causal relationship by adding it into the plurality of recorded causal relationships of player profile 405, as noted in block 707. Recording such causal relationships may be desirable because an updated player profile 405 including such information may allow hub device 401 to more efficiently select actions to execute more likely to improve the mood of player 403 (e.g., avoid selecting action(s) that have been recorded having failed to improve the mood of player 403 under similar circumstances in the past).

Machine learning models, as described herein, may include logistic regression techniques, linear discriminant analysis, linear regression analysis, artificial neural networks, machine learning classifier algorithms, or classification/regression trees in some embodiments. In various other embodiments, machine learning systems may employ Naive Bayes predictive modeling analysis of several varieties, learning vector quantization artificial neural network algorithms, or implementation of boosting algorithms such as Adaboost or stochastic gradient boosting systems for iteratively updating weighting to train a machine learning classifier to determine a relationship between an influencing attribute, such as received device data, and a system, such as an environment or particular user, and/or a degree to which such an influencing attribute affects the outcome of such a system or determination of environment. An AI algorithm for predicting future unstable zones may be configured to consider influencing attributes such as a current usage mapping relating to a particular controller, current usage mappings relating to a plurality of controllers, prior usage mappings relating to either a particular controller or a plurality of controllers, currently determined unstable zones, prior determined unstable zones, or any combination thereof.

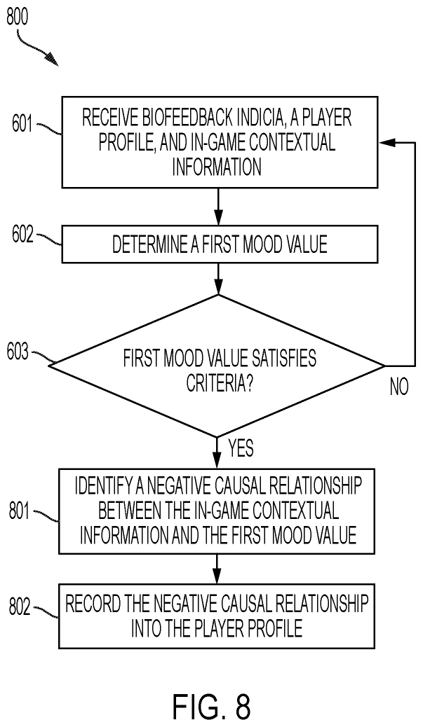

FIG. 8 is an exemplary operational flow diagram illustrating a method 800 for implementing a system for monitoring and regulating moods of a player of gaming applications in accordance with embodiments described above wherein player profile 405 may be updated dynamically using machine learning and based on responses of player 403 to in-game aspects of the gaming application executed on hub device 401. In the example of FIG. 8, system 400 operates according to the steps of method 600, described above, through block 603 wherein hub device 401 determines whether the first mood value satisfies one or more criteria in accordance with embodiments described above.

If, during block 603, hub device 401 determines that the determined first mood value fails to satisfy the one or more criteria, hub device 401 returns to block 601 and continues to monitor the mood of player 403 by receiving updated biofeedback indicia 404, updated information of player profile 405, and updated in-game contextual information 406. If, however, during block 603, hub device 401 determines that the determined first mood value satisfies the one or more criteria, then, in the present embodiment, hub device 401 proceeds to block 801, wherein hub device 401 may identify, using an AI algorithm implemented through one or more machine learning models, a negative causal relationship between the first mood value and the in-game contextual information 406. In some embodiments, this negative causal relationship may represent that the current in-game aspects (e.g., difficulty level, session duration, online multiplayer session, stressful aspects of current game progression level) of the gaming application executed on hub device 401 may have had a deleterious effect on the mood of player 403 (e.g., causing player 403 stress or loss of interest). Further, player profile 405 may include a plurality of recorded causal relationships associated with player 403 and the identification of a negative causal relationship by device 401 may result in a dynamic update of player profile 405 comprising recording the negative causal relationship by adding it into the plurality of recorded causal relationships of player profile 405. Recording such causal relationships may be desirable because an updated player profile 405 including such information may allow hub device 401 to preemptively execute actions to counteract any deleterious effects on the mood of player 403 with which a current in-game aspect may be associated.

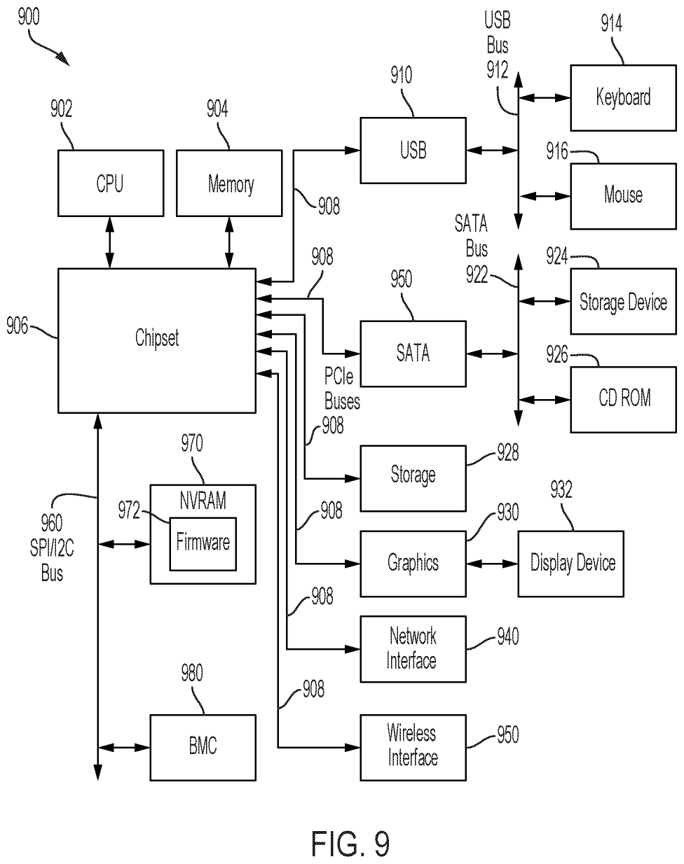

FIG. 9 illustrates an example information handling system 900. Information handling system 900 may include a processor 902 (e.g., a central processing unit (CPU)), a memory (e.g., a dynamic random-access memory (DRAM)) 904, and a chipset 906. In some embodiments, one or more of the processor 902, the memory 904, and the chipset 906 may be included on a motherboard (also referred to as a mainboard), which is a printed circuit board (PCB) with embedded conductors organized as transmission lines between the processor 902, the memory 904, the chipset 906, and/or other components of the information handling system. The components may be coupled to the motherboard through packaging connections such as a pin grid array (PGA), ball grid array (BGA), land grid array (LGA), surface-mount technology, and/or through-hole technology. In some embodiments, one or more of the processor 902, the memory 904, the chipset 906, and/or other components may be organized as a System on Chip (SoC).

The processor 902 may execute program code by accessing instructions loaded into memory 904 from a storage device, executing the instructions to operate on data also loaded into memory 904 from a storage device, and generate output data that is stored back into memory 904 or sent to another component. The processor 902 may include processing cores capable of implementing any of a variety of instruction set architectures (ISAs), such as the x86, POWERPC®, ARM®, SPARC®, or MIPS® ISAs, or any other suitable ISA. In multi-processor systems, each of the processors 902 may commonly, but not necessarily, implement the same ISA. In some embodiments, multiple processors may each have different configurations such as when multiple processors are present in a big-little hybrid configuration with some high-performance processing cores and some high-efficiency processing cores. The chipset 906 may facilitate the transfer of data between the processor 902, the memory 904, and other components. In some embodiments, chipset 906 may include two or more integrated circuits (ICs), such as a northbridge controller coupled to the processor 902, the memory 904, and a southbridge controller, with the southbridge controller coupled to the other components such as USB 910, SATA 920, and PCIe buses 908. The chipset 906 may couple to other components through one or more PCIe buses 908.

Some components may be coupled to one bus line of the PCIe buses 908, whereas some components may be coupled to more than one bus line of the PCIe buses 908. One example component is a universal serial bus (USB) controller 910, which interfaces the chipset 906 to a USB bus 912. A USB bus 912 may couple input/output components such as a keyboard 914 and a mouse 916, but also other components such as USB flash drives, or another information handling system. Another example component is a SATA bus controller 920, which couples the chipset 906 to a SATA bus 922. The SATA bus 922 may facilitate efficient transfer of data between the chipset 906 and components coupled to the chipset 906 and a storage device 924 (e.g., a hard disk drive (HDD) or solid-state disk drive (SDD)) and/or a compact disc read-only memory (CD-ROM) 926. The PCIe bus 908 may also couple the chipset 906 directly to a storage device 928 (e.g., a solid-state disk drive (SDD)). A further example of an example component is a graphics device 930 (e.g., a graphics processing unit (GPU)) for generating output to a display device 932, a network interface controller (NIC) 940, and/or a wireless interface 950 (e.g., a wireless local area network (WLAN) or wireless wide area network (WWAN) device) such as a Wi-Fi® network interface, a Bluetooth® network interface, a GSM® network interface, a 3G network interface, a 4G LTE® network interface, and/or a 5G NR network interface (including sub-6 GHz and/or mmWave interfaces).

The chipset 906 may also be coupled to a serial peripheral interface (SPI) and/or Inter-Integrated Circuit (I2C) bus 960, which couples the chipset 906 to system management components. For example, a non-volatile random-access memory (NVRAM) 970 for storing firmware 972 may be coupled to the bus 960. As another example, a controller, such as a baseboard management controller (BMC) 980, may be coupled to the chipset 906 through the bus 960. BMC 980 may be referred to as a service processor or embedded controller (EC). Capabilities and functions provided by BMC 980 may vary considerably based on the type of information handling system. For example, the term baseboard management system may be used to describe an embedded processor included at a server, while an embedded controller may be found in a consumer-level device. As disclosed herein, BMC 980 represents a processing device different from processor 902, which provides various management functions for information handling system 900. For example, an embedded controller may be responsible for power management, cooling management, and the like. An embedded controller included at a data storage system may be referred to as a storage enclosure processor or a chassis processor.

System 900 may include additional processors that are configured to provide localized or specific control functions, such as a battery management controller. Bus 960 can include one or more busses, including a Serial Peripheral Interface (SPI) bus, an Inter-Integrated Circuit (I2C) bus, a system management bus (SMBUS), a power management bus (PMBUS), or the like. BMC 980 may be configured to provide out-of-band access to devices at information handling system 900. Out-of-band access in the context of the bus 960 may refer to operations performed prior to execution of firmware 972 by processor 902 to initialize operation of system 900.

Firmware 972 may include instructions executable by processor 102 to initialize and test the hardware components of system 900. For example, the instructions may cause the processor 902 to execute a power-on self-test (POST). The instructions may further cause the processor 902 to load a boot loader or an operating system (OS) from a mass storage device. Firmware 972 additionally may provide an abstraction layer for the hardware, such as a consistent way for application programs and operating systems to interact with the keyboard, display, and other input/output devices. When power is first applied to information handling system 900, the system may begin a sequence of initialization procedures, such as a boot procedure or a secure boot procedure. During the initialization sequence, also referred to as a boot sequence, components of system 900 may be configured and enabled for operation and device drivers may be installed. Device drivers may provide an interface through which other components of the system 900 can communicate with a corresponding device. The firmware 972 may include a basic input-output system (BIOS) and/or include a unified extensible firmware interface (UEFI). Firmware 972 may also include one or more firmware modules of the information handling system. Additionally, configuration settings for the firmware 972 and firmware of the information handling system 900 may be stored in the NVRAM 970. NVRAM 970 may, for example, be a non-volatile firmware memory of the information handling system 900 and may store a firmware memory map namespace 900 of the information handling system. NVRAM 970 may further store one or more container-specific firmware memory map namespaces for one or more containers concurrently executed by the information handling system.

Information handling system 900 may include additional components and additional busses, not shown for clarity. For example, system 900 may include multiple processor cores (either within processor 902 or separately coupled to the chipset 906 or through the PCIe buses 908), audio devices (such as may be coupled to the chipset 906 through one of the PCIe busses 908), or the like. While a particular arrangement of bus technologies and interconnections is illustrated for the purpose of example, one of skill will appreciate that the techniques disclosed herein are applicable to other system architectures. System 900 may include multiple processors and/or redundant bus controllers. In some embodiments, one or more components may be integrated together in an integrated circuit (IC), which is circuitry built on a common substrate. For example, portions of chipset 906 can be integrated within processor 902. Additional components of information handling system 900 may include one or more storage devices that may store machine-executable code, one or more communications ports for communicating with external devices, and various input and output (I/O) devices, such as a keyboard, a mouse, and a video display.

In some embodiments, processor 902 may include multiple processors, such as multiple processing cores for parallel processing by the information handling system 900. For example, the information handling system 900 may include a server comprising multiple processors for parallel processing. In some embodiments, the information handling system 900 may support virtual machine (VM) operation, with multiple virtualized instances of one or more operating systems executed in parallel by the information handling system 900. For example, resources, such as processors or processing cores of the information handling system may be assigned to multiple containerized instances of one or more operating systems of the information handling system 900 executed in parallel. A container may, for example, be a virtual machine executed by the information handling system 900 for execution of an instance of an operating system by the information handling system 900. Thus, for example, multiple users may remotely connect to the information handling system 900, such as in a cloud computing configuration, to utilize resources of the information handling system 900, such as memory, processors, and other hardware, firmware, and software capabilities of the information handling system 900. Parallel execution of multiple containers by the information handling system 900 may allow the information handling system 900 to execute tasks for multiple users in parallel secure virtual environments.

The schematic or flow chart diagrams of FIG. 6, FIG. 7, and FIG. 8 are generally set forth as logical flow chart diagrams. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. For example, although processors are described throughout the detailed description, aspects of the invention may be applied to the design of or implemented on different kinds of processors, such as graphics processing units (GPUs), central processing units (CPUs), and digital signal processors (DSPs). As another example, although processing of certain kinds of data may be described in example embodiments, other kinds or types of data may be processed through the methods and devices described above. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method, comprising:
receiving, by a hub device during execution of a gaming application on the hub device, one or more biofeedback indicia for a player of the gaming application via a controller communicatively coupled to the hub, a player profile associated with the player, and in-game contextual information;
determining, by the hub device, a first mood value for the player based on the one or more biofeedback indicia, the player profile, and the in-game contextual information;
determining, by the hub device, that the first mood value satisfies one or more criteria, wherein the one or more criteria is determined based on the player profile and the in-game contextual information; and
executing, by the hub device in response to determining that the first mood value satisfies the one or more criteria, an action based on a rule, wherein the rule is based on the first mood value, the player profile, and the in-game contextual information.

2. The method of claim 1, further comprising:
receiving, by the hub device, after the executing, one or more second biofeedback indicia for the player; and
determining, by the hub device, a second mood value of the player based on the one or more second biofeedback indicia, the player profile, and the in-game contextual information.

3. The method of claim 2, further comprising:
evaluating, by the hub device, that the second mood value is greater than the first mood value;
identifying, in response to the evaluating and using machine learning, a positive causal relationship between the first mood value, the action, and the second mood value; and
recording, by the hub device, the positive causal relationship, wherein the recording comprises adding the positive causal relationship into a plurality of recorded causal relationships included in the player profile.

4. The method of claim 2, further comprising:
evaluating, by the hub device, that the second mood value is not greater than the first mood value;
identifying, in response to the evaluating and using machine learning, a negative causal relationship between the first mood value, the action, and the second mood value; and
recording, by the hub device, the negative causal relationship, wherein the recording comprises adding the negative causal relationship into a plurality of recorded causal relationships included in the player profile.

5. The method of claim 1, further comprising:
identifying, in response to determining that the first mood value satisfies the one or more criteria and using machine learning, a negative causal relationship between the in-game contextual information and the first mood value; and
recording, by the hub device, the negative causal relationship, wherein the recording comprises adding the negative causal relationship into a plurality of recorded causal relationships included in the player profile.

6. The method of claim 1, wherein the one or more biofeedback indicia comprises a heart rate of the player and a grip force of the player on the controller.

7. The method of claim 6, wherein the heart rate is measured via an optical heart rate monitor located on the controller, and wherein the grip force is measured via at least two force sensors located on opposite outward faces of a gripping surface of the controller.

8. The method of claim 1, wherein executing the action comprises initiating haptic cues to the player via the controller, initiating visual lighting cues to the player via the controller, or a combination thereof.

9. A system comprising:
at least one controller communicatively coupled to a hub device executing a gaming application; and
the hub device, configured to:
receive one or more biofeedback indicia for a player of the gaming application via the at least one controller, a player profile associated with the player, and in-game contextual information;
determine a first mood value for the player based on the one or more biofeedback indicia, the player profile, and the in-game contextual information;
determine that the first mood value satisfies one or more criteria, wherein the one or more criteria is determined based on the player profile and the in-game contextual information; and
execute, in response to a determination that the first mood value satisfies the one or more criteria, an action based on a rule, wherein the rule is based on the first mood value, the player profile, and the in-game contextual information.

10. The system of claim 9, wherein the hub device is further configured to:
receive, after executing the action, one or more second biofeedback indicia for the player; and
determine a second mood value of the player based on the one or more second biofeedback indicia, the player profile, and the in-game contextual information.

11. The system of claim 10, wherein the hub device is further configured to:
evaluate that the second mood value is greater than the first mood value;
identify, using machine learning and in response to evaluating that the second mood value is greater than the first mood value, a positive causal relationship between the first mood value, the action, and the second mood value; and
record the positive causal relationship, wherein recording the positive causal relationship comprises adding the positive causal relationship into a plurality of recorded causal relationships included in the player profile.

12. The system of claim 11, wherein the hub device is further configured to:
evaluate that the second mood value is not greater than the first mood value;
identify, using machine learning and in response to evaluating that the second mood value is not greater than the first mood value, a negative causal relationship between the first mood value, the action, and the second mood value; and
record the negative causal relationship, wherein recording the negative causal relationship comprises adding the negative causal relationship into a plurality of recorded causal relationships included in the player profile.

13. The system of claim 9, wherein the hub device is further configured to:
identify, using machine learning and in response to determining that the first mood value satisfies the one or more criteria, a negative causal relationship between the in-game contextual information and the first mood value; and
record the negative causal relationship, wherein recording the negative causal relationship comprises adding the negative causal relationship into a plurality of recorded causal relationships included in the player profile.

14. The system of claim 9, wherein the at least one controller comprises a plurality of force sensors, and wherein the one or more biofeedback indicia comprise information based on signals from the plurality of force sensors.

15. The system of claim 14, wherein the at least one controller further comprises a heart rate monitor, and wherein the one or more biofeedback indicia comprise information based on signals from the heart rate monitor.

16. An information handling system comprising:
a wireless interface;
at least one processor; and
a memory storing instructions executable by the at least one processor to cause the at least one processor to:
receive, during the execution of a gaming application on the at least one processor, one or more biofeedback indicia for a player of the gaming application via a controller communicatively coupled to the at least one processor via the wireless interface, a player profile associated with the player, and in-game contextual information;
determine a first mood value for the player based on the one or more biofeedback indicia, the player profile, and the in-game contextual information;
determine that the first mood value satisfies one or more criteria, wherein the one or more criteria is determined based on the player profile and the in-game contextual information; and
execute, in response to a determination that the first mood value satisfies the one or more criteria, an action based on a rule, wherein the rule is based on the first mood value, the player profile, and the in-game contextual information.

17. The information handling system of claim 16, wherein the instructions executable by the at least one processor further cause the at least one processor to:
receive, after executing the action, one or more second biofeedback indicia for the player; and
determine a second mood value of the player based on the one or more second biofeedback indicia, the player profile, and the in-game contextual information.

18. The information handling system of claim 17, wherein the instructions executable by the at least one processor further cause the at least one processor to:
evaluate that the second mood value is greater than the first mood value;
identify, using machine learning and in response to evaluating that the second mood value is greater than the first mood value, a positive causal relationship between the first mood value, the action, and the second mood value; and
record the positive causal relationship, wherein recording the positive causal relationship comprises adding the positive causal relationship into a plurality of recorded causal relationships included in the player profile.

19. The information handling system of claim 17, wherein the instructions executable by the at least one processor further cause the at least one processor to:
evaluate that the second mood value is not greater than the first mood value;
identify, using machine learning and in response to evaluating that the second mood value is not greater than the first mood value, a negative causal relationship between the first mood value, the action, and the second mood value; and
record the negative causal relationship, wherein recording the negative causal relationship comprises adding the negative causal relationship into a plurality of recorded causal relationships included in the player profile.

20. The information handling system of claim 16, wherein the instructions executable by the at least one processor further cause the at least one processor to:
identify, using machine learning and in response to determining that the first mood value satisfies the one or more criteria, a negative causal relationship between the in-game contextual information and the first mood value; and
record the negative causal relationship, wherein recording the negative causal relationship comprises adding the negative causal relationship into a plurality of recorded causal relationships included in the player profile.
